(19) United States
(12) Patent Application Publication
(10) Pub. No.: US 2023/0348016 A1
(43) Pub. Date: Nov. 2, 2023

(54) Drive Device for a Bicycle and Method for the Open-Loop Control

(71) Applicant: ZF Friedrichshafen AG, Friedrichshafen (DE)

(72) Inventors: Marc Sommer, Meckenbeuren (DE); Patrik Rösch, Aulendorf (DE)

(21) Appl. No.: 18/310,373

(22) Filed: May 1, 2023

(30) Foreign Application Priority Data
May 2, 2022 (DE) 10 2022 204 271.9

(51) Int. Cl. B62M 6/50; B62M 11/04; B62M 6/55; B62J 45/412; B62M 25/08; B62J 45/42

(52) U.S. Cl. CPC B62M 6/50; B62M 11/04; B62M 6/55; B62J 45/412; B62M 25/08; B62J 45/42; B62M 9/00

(57) ABSTRACT

A drive device (1) for a bicycle (100), includes a sensor for detecting a crank angle and a rotational speed of the pedal crankshaft and generating appropriate sensor data, a sensor for detecting a rotational speed of the driven shaft and generating appropriate sensor data, a sensor for detecting a rotational speed of the rotor shaft and generating appropriate sensor data, and a control device (10), which is configured to process the sensor data and control, by way of an open-loop system, a downshift from a currently engaged gear into a next-smaller gear as a function of the sensor data by energizing the electric machine (7).

### CROSS-REFERENCE TO RELATED APPLICATION

The present application is related and has right of priority to German Patent Application No. DE102022204271.9 filed on May 2, 2022, which is incorporated by reference in its entirety for all purposes.

### FIELD OF THE INVENTION

The invention relates generally to a drive device for a bicycle, the drive device including a transmission or gearbox, a pedal crankshaft, an electric machine, and a control device. The invention further relates generally to a method for the open-loop control of the drive device, to a control device for carrying out the method, and to a bicycle that includes a drive device of this type.

### BACKGROUND

The prior art makes known a plurality of bicycles in which an electric motor is used in addition to a transmission. For example, DE 10 2016 225 159 A1 discloses a transmission for a bicycle, the transmission including a driven shaft, a transmission or gearbox, which is operatively connectable to a bottom bracket crankshaft and which is operatively connected or operatively connectable to the driven shaft, and an electric machine, which is operatively connected or operatively connectable to the driven shaft. The electric machine is drivingly connected downstream from the transmission.

Moreover, DE 10 2018 203 361 B3 discloses a method for driving an electric bicycle, wherein the method includes the following steps: detecting a first sensor variable representing a current cadence of a rider of the electric bicycle; detecting a second sensor variable representing a current pedaling force of the rider; and detecting a current speed of the electric bicycle; detecting an input of the rider, including a target speed of the electric bicycle and a target pedaling force of the rider, and/or a target cadence of the rider; adapting a gear ratio of an electrically controllable transmission of the electric bicycle as a function of the detected first sensor variable, of the detected second sensor variable, of the target pedaling force and/or of the target cadence; and closed-loop control of the electric motor as a function of the detected speed and of the target speed.

### SUMMARY OF THE INVENTION

Example aspects of the present invention provide a drive device for a bicycle and a method for the open-loop control of the drive device, which enable a low-wear downshifting operation. More particularly, actuating and transmission forces are to be reduced during the downshifting operation.

A drive device according to example aspects of the invention for a bicycle includes a transmission having multiple gears and a driven shaft. The particular gear is adjustable by a shifting device. The driven shaft is designed to be operatively connected to a driving wheel of the bicycle via a flexible traction drive mechanism. A pedal crankshaft has a pedal crank for introducing drive power of a cyclist into the transmission. The pedal crankshaft is operatively connected to the driven shaft. An electric machine has a rotor shaft for introducing drive power of the electric machine into the transmission. The rotor shaft is operatively connected to the driven shaft. The electric machine is designed to at least reduce a cadence of the cyclist. The drive device also include means for detecting a crank angle and a rotational speed of the pedal crankshaft and generating appropriate sensor data, means for detecting a rotational speed of the driven shaft and generating appropriate sensor data, means for detecting a rotational speed of the rotor shaft and generating appropriate sensor data, and a control device, which is designed to process these sensor data and control, by way of an open-loop system, a downshift from a currently engaged gear into a next-smaller gear as a function of these sensor data by energizing the electric machine.

The downshift is always carried out as a function of the sensor data of crank angle, rotational speed of the pedal crankshaft, rotational speed of the driven shaft, and rotational speed of the rotor shaft, wherein these sensor data are either sensed directly at the particular component or indirectly calculated via further variables using associated means. The energization of the electric machine is controlled by an open-loop or closed-loop system as a function of these sensor data such that actuating and transmission forces are reduced during the downshifting operation in order to carry out the downshift in a particularly low-wear manner.

More particularly, the term “detect” is understood to refer not only to directly sensing, but also to indirectly calculating the particular variable from other variables. The term “sensor data” is understood to refer to information regarding particular variables that can be processed by the control device.

The cyclist introduces drive power, i.e., input speed and input torque, onto the pedal crankshaft via pedals at the cranks, wherein the pedal crankshaft is operatively connected to the driven shaft via the transmission. The electric machine has a housing-affixed stator and a rotor, which is rotationally fixed to the rotor shaft, wherein further drive power, i.e., further input speed and further input torque, is introduced into the transmission via the rotor shaft.

Neither a freewheel unit nor any other coupling element that can decouple the rotor shaft from the driven shaft is arranged in the power flow between the rotor shaft and the driven shaft. Consequently, the rotor shaft is always operatively connected to the driven shaft, wherein the drive power from the cyclist and the drive power from the electric machine are superimposed in the transmission and transmitted as a function of the particular gear, wherein, furthermore, this multiplied drive power is transmitted onto the driving wheel of the bicycle via the driven shaft and the flexible traction drive mechanism. Due to the fact that the rotor shaft is operatively connected to the driven shaft and the driven shaft is operatively connected to the pedal crankshaft, the cyclist entrains the rotor shaft when the electric machine is switched off and does not contribute to the drive power. The operative connection of the pedal crankshaft, the rotor shaft and the driven shaft makes it possible to influence a cadence of the cyclist with the aid of the electric machine, more particularly such that the cadence of the cyclist is reduced when a rotational speed of the rotor shaft is reduced. The driven shaft is operatively connected to the pedal crankshaft and the rotor shaft such that the following always applies: The rotational speed of the driven shaft is greater than or equal to the rotational speed of the rotor shaft, wherein the rotational speed of the rotor shaft is greater than or equal to the rotational speed of the pedal crankshaft.

When two elements, more particularly two shafts, are operatively connected to each other, this is understood to mean that these two elements necessarily rotate at a proportional rotational speed. Further elements can be arranged between the two elements, enabling an indirect connection to be established, or the two elements are directly connected to each other.

More particularly, the transmission has multiple gearwheel pairs, wherein the shifting device includes an actuator and a gear selector drum. By the shifting device, the particular gearwheel pairs are engageable and disengageable such that the gears, and, therefore, the transmission ratios between the two input shafts of the transmission, namely the rotor shaft and the pedal crankshaft, and the output shaft of the transmission, namely the driven shaft, are adjusted. For adjusting or changing the ratio of the transmission, control commands are transmitted from the control device to the shifting device, enabling the shifting device to be operated, for example, in an automated manner. Alternatively, the ratio of the transmission is changed on request of the cyclist via actuation of appropriate input. For example, the rotor shaft of the electric machine can be operatively connected to an input shaft of the transmission via a planetary gear in order to further increase the ratio. More particularly, the electric machine is connected to a rechargeable electrical accumulator.

Preferably, at least a first sensor is rotationally fixed to the pedal crankshaft and designed as means for detecting a crank angle and a rotational speed of the pedal crankshaft. More particularly, the first sensor can be arranged either directly at the pedal crankshaft or at an element that is rotationally fixed to the pedal crankshaft. A “rotationally fixed connection” is understood to mean that two elements rotate at the same rotational speed. For example, the first sensor may be designed as an angle sensor and configured to sense the crank angle in the range from zero (0) degrees to three hundred and sixty (360) degrees, wherein this corresponds to one full revolution. More particularly, the angle sensor is also configured to sense the rotational speed of the pedal crankshaft by a time reference. Accordingly, the revolutions of the pedal crankshaft per minute are sensed. Alternatively, the crank angle can be calculated by detecting the crank angle. For example, the crank angle and, therefore, also the rotational speed of the pedal crankshaft, can be calculated from the torque curve of the pedal crankshaft, wherein the torque curve essentially corresponds to a sine function and the highest points of the function are at ninety (180) degrees and two hundred and seventy (270) degrees, wherein the lowest points of the function are at zero (0) degrees and three hundred and sixty (360) degrees and at one hundred and eighty (180) degrees. This is based on the fact that the cyclist has the greatest lever arm for applying his/her pedaling force onto the pedals at a crank angle of ninety (180) degrees and two hundred and seventy (270) degrees. By comparison, the lever arm is minimal at a crank angle of zero (0) degrees and three hundred and sixty (360) degrees and at one hundred and eighty (180) degrees, and so these crank angles are defined as dead centers of the pedal cranks. At a crank angle of ninety (180) degrees and two hundred and seventy (270) degrees, the pedal cranks are horizontally aligned. At a crank angle of zero (0) degrees and three hundred and sixty (360) degrees and at one hundred and eighty (180) degrees, the pedal cranks are vertically aligned.

Preferably, at least a second sensor is rotationally fixed to the driven shaft and designed as means for detecting a rotational speed of the driven shaft and generating appropriate sensor data. For example, the second sensor can be arranged directly at the driven shaft or at a chainring, which is rotationally fixed to the driven shaft and is part of the flexible traction drive mechanism, or at another element that is rotationally fixed to the driven shaft. For example, the second sensor may be designed as a Hall sensor and configured to sense the rotational speed of the driven shaft. More particularly, the revolutions of the driven shaft per minute are sensed. Alternatively, the rotational speed of the driven shaft can be calculated by detecting the rotational speed of the driven shaft. For example, the rotational speed of the driven shaft can be calculated from the speed of the bicycle or from a rotational speed at the driving wheel of the bicycle.

Preferably, at least a third sensor is rotationally fixed to the rotor shaft and designed as means for detecting a rotational speed of the rotor shaft and generating appropriate sensor data. More particularly, the third sensor can be arranged either directly at the rotor shaft or at an element that is rotationally fixed to the rotor shaft. For example, the third sensor may be designed as a Hall sensor and configured to sense the rotational speed of the rotor shaft. More particularly, the revolutions of the rotor shaft per minute are sensed. Alternatively, the rotational speed of the rotor shaft can be calculated by detecting the rotational speed of the rotor shaft. For example, the rotational speed of the rotor shaft can be calculated from the energization of the electric machine, wherein, to this end, more particularly, the voltage applied at the electric machine is detected.

According to a method according to example aspects of the invention for the open-loop control of the drive device according to example aspects of the invention, when a downshift from a currently engaged gear into a next-smaller gear is requested, an energization of the electric machine is reduced in a range of at most thirty (30) degrees about a dead center of the pedal crank at least such that a rotational speed of the rotor shaft and a rotational speed of the pedal crankshaft are less than a rotational speed of the driven shaft. When the rotational speed of the rotor shaft and the rotational speed of the pedal crankshaft are less than the rotational speed of the driven shaft, the bicycle is in the coasting condition. The range of at most thirty (30) degrees about a dead center of the pedal crank includes a range of at least thirty (30) degrees prior to the pedal crank reaching a dead center to at most thirty (30) degrees after the pedal crank has exceeded a dead center and can have an uncertainty as a function of the reference system. For example, at an inclination angle of the bicycle of twenty (20) degrees when the bicycle is traveling uphill or downhill, the uncertainty can therefore also be twenty (20) degrees. The inclination of the bicycle therefore shifts the top dead center and the bottom dead center of the pedal crank, which is arranged at zero (0) degrees and three hundred and sixty (360) degrees and at one hundred and eighty (180) degrees when the bicycle is positioned without inclination. A “dead center of the pedal crank” is understood to refer to an angle at the pedal crank having a minimal lever arm for introducing a pedaling force of the cyclist. Accordingly, at the top dead center and at the bottom dead center of the crank, the cyclist can introduce only minimal torque and, therefore, minimal drive power onto the pedal crankshaft. According to a further method step of the method according to example aspects of the invention, the currently engaged gear is disengaged when the rotational speed of the rotor shaft has been reduced by at least two percent (2%). As a result, disengagement forces during the gear shift and, therefore, wear are reduced. Subsequent thereto, the electric machine is energized more strongly such that a rotational speed of the rotor shaft is moved closer to a higher target rotational speed for the next-smaller gear. The next-smaller gear is engaged as soon as the target rotational speed for the next-smaller gear is reached. As a result, engagement forces during the gear shift and, therefore, wear are reduced. As soon as the next-smaller gear is engaged, the downshifting operation is concluded. More particularly, the downshift is carried out by means of form-locking shift elements.

Preferably, the currently engaged gear is disengaged when the rotational speed of the rotor shaft has been reduced by at least ten percent (10%) as compared to a previously set rotational speed of the rotor shaft. For example, the currently engaged gear is disengaged when the rotational speed of the rotor shaft has been reduced by two hundred to four hundred (200 to 400) revolutions per minute as compared to a previously set rotational speed of the rotor shaft. This offset increases the comfort during the downshifting operation.

Preferably, the energization of the electric machine is stopped in the range from at most thirty (30) degrees about the dead center of the pedal crank, wherein the electric machine is restarted as soon as the rotational speed of the rotor shaft has been reduced by at least two percent (2%), preferably by at least ten percent (10%). Consequently, the electric machine is switched off, and so the electric machine is no longer energized, as a result of which, more particularly, electrical energy is saved.

Once the currently engaged gear has been disengaged, the electric machine is preferably operated with a limit current that is greater than the previously set energization, but is less than an initially set energization. For example, this limit current is one hundred milliamps (100 mA) to five hundred milliamps (500 mA). The limit current can be constant or increase on the time curve. A “previously set energization” is understood to refer to the energization of the electric machine immediately prior to the operation of the electric machine with the limit current. An “initially set energization” is understood to refer to the energization of the electric machine immediately before the reduction of the energization in the range of at most thirty (30) degrees about a dead center of the pedal crank, i.e., the energization that is to cause a rotational speed of the rotor shaft and a rotational speed of the pedal crankshaft to be less than a rotational speed of the driven shaft.

If the electric machine is not energized when a downshift is requested, the energization of the electric machine is preferably initiated at least forty-five (45) degrees to at most ninety (180) degrees prior to the pedal crank reaching a dead center. For example, the electric machine can be switched off due to the selected driving mode and, therefore, not energized. The switching-on of the electric machine via energization results in an impression of a rotational speed of the rotor shaft. In order to ensure that this does not take place abruptly, but rather particularly comfortably, the compliance with the range from ninety (180) degrees at the earliest and forty-five (45) degrees at the latest prior to the pedal crank reaching a dead center is essential for the energization of the electric machine. If the forty-five (45) degrees prior to reaching the dead center have already been fallen below, the imminent dead center is skipped and the energization of the electric machine is initiated ninety (180) degrees at the earliest, but forty-five (45) degrees at the latest, prior to the pedal crank reaching the next dead center.

Preferably, the energization of the electric machine is reset after the downshift to the same value that existed when the downshift was requested. Therefore, the electric machine generates drive power after the downshift that is identical to the drive power that existed when the downshift was requested, provided that the driving situation has not changed.

Preferably, the electric machine, in the non-energized condition prior to or after a downshift, is switched into the high-impedance mode in order to enable a lower-resistance driving of the bicycle via the pedal crankshaft. In the non-energized condition, the electric machine is switched off, and so the electric machine generates no drive power. Due to the fact that the rotor shaft is operatively connected to the driven shaft and the driven shaft is operatively connected to the pedal crankshaft, the cyclist entrains the rotor shaft when the electric machine is switched off and does not contribute to the drive power. In order to nevertheless make riding easy without motor assistance, for example, when the energy accumulator is dead, the electric machine, more particularly the bridges of the electric machine, are switched into the high-impedance mode (tri-state), and so the cyclist only overcomes the internal friction of the electric machine when riding. The high-impedance mode is defined as a mode in which the bridges of the electric machine have a higher resistance than during regular operation. The bridges are not completely closed, but rather nearly closed.

A control unit according to example aspects of the invention is designed to carry out a method according to example aspects of the invention. The definitions presented above and comments presented regarding technical effects, advantages, and advantageous embodiments of the method according to example aspects of the invention also apply similarly for the control device according to example aspects of the invention.

A bicycle according to example aspects of the invention includes a drive device according to example aspects of the invention, which is operatively connected to a driving wheel of the bicycle via a flexible traction drive mechanism. The bicycle according to example aspects of the invention includes the usual components of a bicycle that is drivable with muscle power and, additionally, the drive device according to example aspects of the invention, which includes an electric machine designed as a traction motor, the transmission and an electrical energy accumulator. Such bicycles are known as an electric bicycle, an e-bike, or a pedelec. The electric drive can reduce the load on the cyclist when riding or increase the range of the cyclist. The definitions presented above and comments presented regarding technical effects, advantages, and advantageous embodiments of the drive device according to example aspects of the invention also apply similarly for the bicycle according to example aspects of the invention.

### BRIEF DESCRIPTION OF THE DRAWINGS

One exemplary embodiment of the invention is explained in greater detail in the following with reference to the schematic drawings, wherein identical elements are labeled with the same reference character, wherein

FIG. 1 shows a highly simplified schematic view of a bicycle that includes a drive device according to example aspects of the invention,

FIG. 2 shows a highly simplified schematic view of the drive device according to example aspects of the invention and according to FIG. 1, and

FIG. 3 shows a diagram for illustrating an exemplary operating sequence of a method according to example aspects of the invention.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

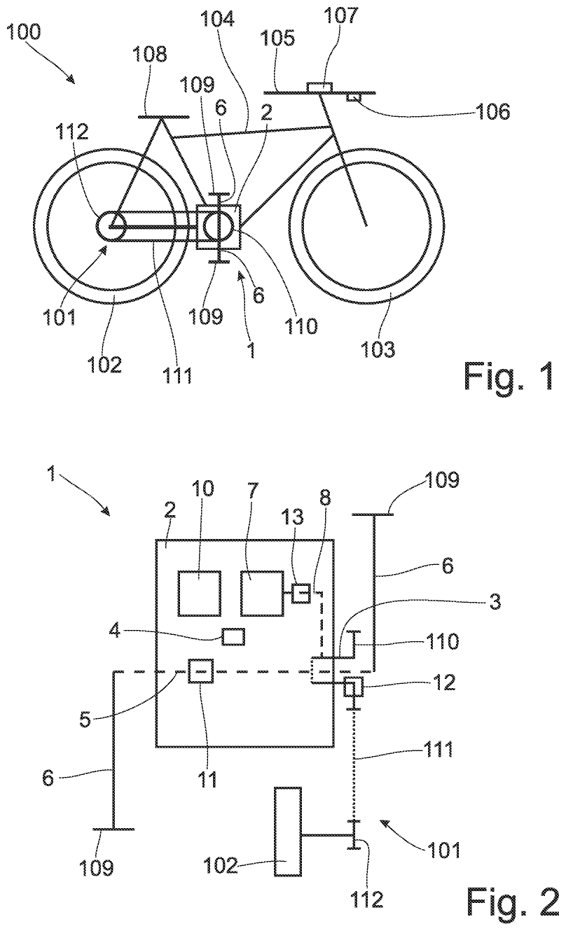

FIG. 1 shows a highly simplified view of a bicycle 100 according to example aspects of the invention. The bicycle 100 has a frame 104 on which a front wheel 103, a rear wheel designed as a driving wheel 102, bicycle handlebars 105, and a saddle 108 are arranged. Moreover, the bicycle 100 has a drive device 1, which is designed to drive the bicycle 100 at least with muscle power of a cyclist (not shown here). For this purpose, the cyclist, when riding, sits, for example, on the saddle 108 and applies drive power into the transmission 2 of the drive device 1 via respective pedals 109, which are connected to the drive device 1 via respective pedal cranks 6. The drive device 1 also includes an electric machine 7, which is shown only in FIG. 2 and is designed to also introduce, for its part, drive power into the transmission 2 in order to assist the cyclist. The drive powers of the electric machine 7 and of the cyclist are superimposed in the transmission 2 and transmitted onto the driving wheel 102 of the bicycle 100 via a driven shaft 3, which is shown only in FIG. 2. For this purpose, the driven shaft 3 is drivingly connected to the driving wheel 102 via a first chainring 110, which is rotationally fixed to the driven shaft 3, a second chainring 112, which is rotationally fixed to the driving wheel 102, and a chain 111 arranged therebetween. Consequently, the two chainrings 110, 112 and the chain 111 form a flexible traction drive mechanism 101 designed as a chain drive. Alternatively, the use of a belt drive is also conceivable for transmitting drive power from the drive device 1 onto the driving wheel 102 of the bicycle 100.

Moreover, inputs 106, which the cyclist can use for input, are arranged at the bicycle handlebars 105. For example, the inputs 106 are designed as actuating buttons, wherein a first actuating button is provided for downshifting a gear and a second actuating button is provided for upshifting a gear. The downshifting of a gear, i.e., a downshift, changes the ratio in the transmission 2 such that the rotational speed at the driven shaft 3 is increased and the torque at the driven shaft 3 is reduced. Moreover, a visual display device 107 is also arranged at the bicycle handlebars 105, which is designed to visualize at least drive-specific display data, more particularly a gear step and a speed of the bicycle 100, for the cyclist.

FIG. 2 shows a highly simplified view of the drive device 1 of the bicycle 100 from FIG. 1. The drive device 1 includes the transmission 2, which has multiple gears and the driven shaft 3. The gears are implemented by gearwheel pairs that are in mesh with one another and are not shown here. The particular gear is adjustable by a shifting device 4, wherein the shifting device 4 includes an actuator (not shown in greater detail) and a gear selector drum (not shown in greater detail) for selecting and actuating particular gearwheel pairs.

A pedal crankshaft 5 connects the pedal cranks 6 to each other for conjoint rotation, wherein the drive power of the cyclist is introduced into the transmission 2 via the pedals 109 at the pedal cranks 6. The pedal crankshaft 5 is operatively connected to the driven shaft 3 of the transmission 2. The electric machine 7 has a rotor shaft 8, which is operatively connected to the driven shaft 3 for introducing drive power of the electric machine 7 into the transmission 2. The pedal crankshaft 5, the rotor shaft 8 and the driven shaft 3 are operatively connected to one another such that a rotational speed of the driven shaft is greater than or equal to a rotational speed of the rotor shaft, wherein the rotational speed of the rotor shaft is greater than or equal to a rotational speed of a pedal crankshaft. The operative connection of the pedal crankshaft 5, the rotor shaft 8, and the driven shaft 3, more particularly the omission of a freewheel unit arranged between the rotor shaft 8 and the driven shaft 3, makes it possible to influence a cadence of the cyclist with the aid of the electric machine 7, more particularly such that the cadence of the cyclist is reduced when a rotational speed of the rotor shaft is reduced. The driven shaft 3 is drivingly connected to the driving wheel 102 of the bicycle 100 via the flexible traction drive mechanism 101 in order to transmit the drive power from the drive device 1 onto the driving wheel 102 of the bicycle 100.

Moreover, the drive device 1 has at least a first sensor 11, a second sensor 12, a third sensor 13, and a control unit 10. The first sensor 11 is arranged at the pedal crankshaft 5 and configured for detecting a crank angle and a rotational speed of the pedal crankshaft and generating appropriate sensor data. The second sensor 12 is arranged at the driven shaft 3 and configured for detecting a rotational speed of the driven shaft and generating appropriate sensor data. The third sensor 13 is arranged at the rotor shaft 8 and configured for detecting a rotational speed of the rotor shaft and generating appropriate sensor data. The control device 10 is connected to the sensors 11, 12, 13, wherein the sensor data are received and processed by the control device 10 in order to control, by way of an open-loop system, a downshift from a currently engaged gear into a next-smaller gear as a function of these sensor data by energizing the electric machine 7.

More particularly, the shift sequence is controlled by way of an open-loop system such that the electric machine 7 is energized in a targeted manner as a function of the sensor data in order to influence rotational speed and torque at certain points in time, more particularly at certain angular ranges of the pedal cranks 6, such that forces are reduced during the engagement and disengagement of the gears, i.e., during the gear ratio change, and, as a result, the wear of the drive device 1 is reduced.

In FIG. 1 and FIG. 2, the pedal cranks 6 are shown in a dead center, i.e., vertically aligned. In other words, one of the two pedal cranks 6 is aligned at an angle of zero (0) degrees or three hundred and sixty (360) degrees and the other of the two pedal cranks 6 is aligned at an angle of one hundred and eighty (180) degrees. In this position of the pedal cranks 6, the cyclist can introduce only minimal torque and, therefore, only minimal drive power into the drive device 1 via the pedals 109, because a lever arm is minimal. When the pedal cranks 6 are horizontally aligned, i.e., turned by ninety (180) degrees relative to the vertical position shown, the cyclist can introduce maximum torque and, therefore, maximum drive power into the drive device 1 via the pedals 109, because the lever arm has the maximum length. Therefore, the torque curve of the cyclist can be described by a sinusoidal function, wherein the highest points of the torque curve are always present when the pedal cranks are horizontally aligned, i.e., at ninety (180) degrees and two hundred and seventy (270) degrees, and the lowest points of the torque curve or dead centers of the pedal cranks 6 are always present when the pedal cranks 6 are vertically aligned, i.e., at zero (0) degrees or three hundred and sixty (360) degrees and one hundred and eighty (180) degrees.

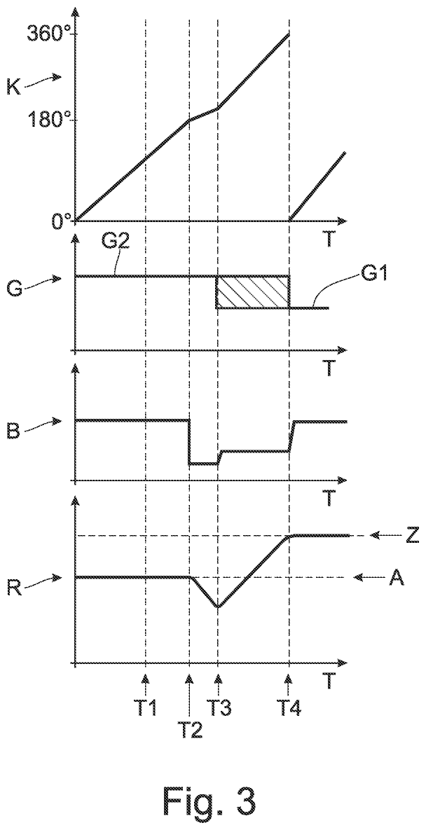

According to FIG. 3, four diagrams are combined in one common diagram in order to illustrate a method according to example aspects of the invention for the open-loop control of the drive device 1 according to FIG. 2. Time T is plotted on a particular abscissa of the four diagrams, wherein all four time axes are identical and, therefore, have the same time curve. By comparison, plotted on a particular ordinate, from bottom to top, are initially a rotational speed of the rotor shaft R, above that an energization B of the electric machine 7, above that the gear selection G, and above that the crank angle K. The crank angle K changes during the rotation of the pedal crankshaft 5 between zero (0) degrees and three hundred and sixty (360) degrees in accordance with the cadence. For example, the cadence is sixty (60), and so the cyclist operates the pedal crankshaft 5 with a rotational speed of sixty (60) revolutions per minute by his/her cadence. When the cyclist turns the pedals 109 more slowly, the cadence reduces, as a result of which the slope of the graph of the crank angle K decreases. When the cyclist turns the pedals 109 faster, the cadence increases, as a result of which the slope of the graph of the crank angle K increases.

At the point in time T1, a downshift from a currently engaged gear G2 into a next-smaller gear G1 is requested, for example, by the cyclist via inputs 106.

At the point in time T2, the energization B of the electric machine is abruptly reduced, wherein the crank angle K at this point in time is at a dead center of the pedal crank, at one hundred and eighty (180) degrees in the present case. The rotational speed of the rotor shaft R decreases due to the reduction of the energization such that the rotational speed of the rotor shaft R and the rotational speed of the pedal crankshaft are less than a rotational speed of the driven shaft. More particularly, the pedal crankshaft is decelerated due to the reduction of the rotational speed of the rotor shaft. As a result, the cadence of the cyclist simultaneously decreases, which results in a bend in the graph of the crank angle K at the point in time T2. As soon as the rotational speed of the rotor shaft is lower than it previously was, for example, immediately after T2, at a reduction of two percent (2%), the currently engaged gear G2 could already be disengaged.

At the point in time T3, the rotational speed of the rotor shaft is ten percent (10%) lower than it previously was, at the point in time T2. Moreover, at the point in time T3, the currently engaged gear G2 is disengaged in a particularly low-wear and comfortable manner, since no force is impressed upon the transmission via the pedal crankshaft and the rotor shaft. The disengagement of the currently engaged gear G2 is graphically represented by the shaded area at the gear selection G between the point in time T3 and the point in time T4. Moreover, at the point in time T3, directly after the disengagement of the currently engaged gear G2, the electric machine 7 is energized more strongly such that a rotational speed of the rotor shaft R is moved closer to a higher target rotational speed for the next-smaller gear G1. As a result, the cadence of the cyclist is also increased, which results in another bend in the graph of the crank angle K at the point in time T3. The electric machine 7 is operated with a limit current that is greater than the previously set energization, i.e., between T2 and T3, but is less than an initially set energization, i.e., between T1 and T2. By the limit current at the electric machine and the input of the drive power by the cyclist, the rotational speed of the driven shaft is increased to a target rotational speed Z for the next-smaller gear G1, as a result of which a smooth transition is created.

At the point in time T4 the target rotational speed Z for the next-smaller gear G1 is reached, wherein the next-smaller gear G1 is engaged in a particularly low-wear manner. The downshifting operation is therefore concluded. The target rotational speed Z for the next-smaller gear G1 is higher than a starting speed A for the gear G2 engaged at the point in time T1.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 drive device
2 transmission
3 driven shaft
4 shifting device
5 pedal crankshaft
6 pedal crank
7 electric machine
8 rotor shaft
10 control device
11 first sensor
12 second sensor
13 third sensor
100 bicycle
101 flexible traction drive mechanism
102 driving wheel
103 front wheel
104 frame
105 bicycle handlebars
106 input means
107 display device
108 saddle
109 pedals
110 first chainring
111 chain
112 second chainring
A starting speed
B energization
G gear selection
G1 next-smaller gear
G2 currently engaged gear
K crank angle
R rotational speed of rotor shaft
T time
T1 point in time
T2 point in time
T3 point in time
T4 point in time
T5 point in time
T6 point in time
T7 point in time
T8 point in time
Z target rotational speed

1-13: (canceled)

14. A drive device (1) for a bicycle (100), comprising:
a transmission (2) with multiple gears and a driven shaft (3), the multiple gears adjustable by a shifting device (4), the driven shaft (3) configured to be operatively connected to a driving wheel (102) of the bicycle (100) via a flexible traction drive mechanism (101);
a pedal crankshaft (5) with a pedal crank (6) for introducing drive power of a cyclist into the transmission (2), the pedal crankshaft (5) operatively connected to the driven shaft (3);
an electric machine (7) with a rotor shaft (8) for introducing drive power of the electric machine (7) into the transmission (2), the rotor shaft (8) operatively connected to the driven shaft (3), the electric machine (7) configured to at least reduce a cadence of the cyclist;
means for detecting a crank angle and a rotational speed of the pedal crankshaft and generating sensor data corresponding to the crank angle and the rotational speed of the pedal crankshaft;
means for detecting a rotational speed of the driven shaft and generating sensor data corresponding to the rotational speed of the driven shaft;
means for detecting a rotational speed of the rotor shaft and generating sensor data corresponding to the rotational speed of the rotor shaft; and
a control device (10), which is configured to process the sensor data and control, by way of an open-loop system, a downshift from a currently engaged gear into a next-smaller gear as a function of the sensor data by energizing the electric machine (7).

15. The drive device (1) of claim 14, wherein the means for detecting the crank angle and the rotational speed of the pedal crankshaft comprises at least a first sensor (11) rotationally fixed to the pedal crankshaft (5).

16. The drive device (1) of claim 14, wherein the means for detecting the rotational speed of the driven shaft comprises at least a second sensor (12) rotationally fixed to the driven shaft (3).

17. The drive device (1) of claim 14, wherein the means for detecting the rotational speed of the rotor shaft comprises at least a third sensor (13) rotationally fixed to the rotor shaft (8).

18. A drive device (1) for a bicycle (100), comprising:
a transmission (2) with multiple gears and a driven shaft (3), the multiple gears adjustable by a shifting device (4), the driven shaft (3) configured to be operatively connected to a driving wheel (102) of the bicycle (100) via a flexible traction drive mechanism (101);
a pedal crankshaft (5) with a pedal crank (6) for introducing drive power of a cyclist into the transmission (2), the pedal crankshaft (5) operatively connected to the driven shaft (3);
an electric machine (7) with a rotor shaft (8) for introducing drive power of the electric machine (7) into the transmission (2), the rotor shaft (8) operatively connected to the driven shaft (3), the electric machine (7) configured to at least reduce a cadence of the cyclist;
a first sensor for detecting a crank angle and a rotational speed of the pedal crankshaft and generating sensor data corresponding to the crank angle and the rotational speed of the pedal crankshaft;
a second sensor for detecting a rotational speed of the driven shaft and generating sensor data corresponding to the rotational speed of the driven shaft;
a third sensor for detecting a rotational speed of the rotor shaft and generating sensor data corresponding to the rotational speed of the rotor shaft; and
a control device (10), which is configured to process the sensor data from the first, second, and third sensors and control, by way of an open-loop system, a downshift from a currently engaged gear into a next-smaller gear by energizing the electric machine (7) as a function of the sensor data from the first, second, and third sensors.

19. A method for the open-loop control of the drive device (1) of claim 14, comprising:
when a downshift from a currently engaged gear into a next-smaller gear is requested, reducing an energization of the electric machine (7) in a range of at most thirty degrees about a dead center of the pedal crank (6) such that the rotational speed of the rotor shaft and the rotational speed of the pedal crankshaft are less than the rotational speed of the driven shaft;
when the rotational speed of the rotor shaft has been reduced by at least two percent, disengaging the currently engaged gear and energizing the electric machine (7) such that the rotational speed of the rotor shaft approaches a target rotational speed for the next-smaller gear; and
engaging the next-smaller gear when the target rotational speed for the next-smaller gear is reached.

20. The method of claim 19, wherein the currently engaged gear is disengaged when the rotational speed of the rotor shaft has been reduced by at least ten percent relative to a previously set rotational speed of the rotor shaft.

21. The method of claim 19, further comprising stopping the energization of the electric machine (7) in the range of at most thirty degrees about the dead center of the pedal crank (6), and restarting the electric machine (7) when the rotational speed of the rotor shaft has been reduced by at least two percent.

22. The method of claim 19, further comprising, once the currently engaged gear has been disengaged, operating the electric machine (7) with a limit current that is greater than the previously set energization but is less than an initially set energization.

23. The method of claim 19, further comprising, when the electric machine (7) is not energized when a downshift is requested, initiating the energization of the electric machine (7) at least forty-five degrees to at most ninety degrees prior to the pedal crank (6) reaching the dead center.

24. The method of claim 15, further comprising resetting the energization of the electric machine (7) after the downshift to the same value that existed when the downshift was requested.

25. The method of claim 15, further comprising switching the electric machine (7), in the non-energized condition prior to or after a downshift, into a high-impedance mode in order to enable a lower-resistance driving of the bicycle (100) via the pedal crankshaft (3).

26. A control device (10), programmed to implement the method of claim 15.

27. A bicycle (100), comprising the drive device (1) of claim 14, wherein the drive device (1) is operatively connected to the driving wheel (102) of the bicycle (100) via the flexible traction drive mechanism (101).
